(19) United States
(12) Patent Application Publication
(10) Pub. No.: US 2023/0338965 A1
(43) Pub. Date: Oct. 26, 2023

(54) AERO-ACOUSTIC MATERIALS PROCESSING APPARATUS AND METHOD

(71) Applicants: Janusz Franciszek LUTEREK, Pretoria (ZA); VORTEX INDUSTRIAL SOLUTIONS LTD, EBENE (MU)

(72) Inventor: Colin Rawson, Victoria (AU)

(21) Appl. No.: 18/048,171

(22) PCT Filed: May 6, 2021
(86) PCT No.: PCT/ZA2021/050027

§ 371 Date: Oct. 20, 2022

(30) Foreign Application Priority Data
May 7, 2020 (ZA) 2020/02500

(51) Int. Cl. B02C 19/18; B02C 19/06; F04D 29/22; F04D 17/08

(52) U.S. Cl. CPC B02C 19/18; B02C 19/061; F04D 29/2288; F04D 17/08

(57) ABSTRACT

The invention is an aero-acoustic comminution apparatus which includes an aero-acoustic comminution machine 10 having a cyclone chamber 12 with an inlet 14 for the material to be comminuted and an inlet 16 for the air. An electric motor 18 coupled to a shaft 20 to which an impeller 22 is coupled rotates the impeller 22 within an impeller housing 24 to draw the air and the entrained material to be comminuted into the cyclone chamber 12 and through an axial inlet system 26 into the impeller 22 and impeller housing 24 and to expel the comminuted material through the impeller housing 24 radially through a transverse outlet. The invention extends to a method of comminuting an ore material using said aero-acoustic comminution apparatus as well as an organic material. The invention further extends to aero-acoustic materials processing plant including said aero-acoustic comminution apparatus and further comprising an enclosure surrounding the aero-acoustic including sound attenuation panels having 4 or more layers which include a plasticised film.

### FIELD OF THE INVENTION

The invention relates to aero-acoustic materials processing apparatus and to methods of using the apparatus for the comminution of various materials.

### BACKGROUND TO THE INVENTION

WO 98/35756 discloses that it was found that a cyclone created in a stream of air passing through a conduit, preferably of circular cross-section, the centripetal forces created by the motion of the air stream pull any particulate material entrained in the air stream away from the walls of the conduit and towards its central region. If a wide range of sonic frequencies are created within the conduit, a pattern of powerful vortices are created in the air stream. Energies are released by conversion of the potential energy to kinetic energy due to the stresses created within the cyclone which causes a minute explosion. The vortices of the cyclone take the form of implosions which are capable of breaking the material up further into smaller particles.

It was also found that the vortices created in the cyclonic air stream carry further harmonic frequencies generated by the specially designed apparatus, this sets up a pulse from the standing wave configuration within the system, and this causes pockets of air within the standing wave to achieve a velocity beyond the sonic range. This can be tuned for a particular type of material which enhances the ability of the vortices created to break up very hard and soft materials such as stone and to dry materials.

In US 2011/0114766A1, Hazarika et al provides a method for size reduction of a material comprising the steps of: feeding material through a feed assembly into a cyclone chamber, the cyclone chamber having an elongate cylindrical conduit having a frusto-conical section; adding at least one viscosity modifying agent into the cyclone chamber; and providing a cyclonic fluid stream within the cyclone chamber, and an apparatus for carrying out the method.

In WO 2018/187848 the inventor, who is also an inventor of the present invention, disclosed that a form of aero-acoustic grinding machine had been developed, referred to therein as a “vortex machine” for convenience. The vortex machine is an extreme aero-acoustic device that may be used to mill, grind, blend and dry a wide range of materials. The nature of the machine is such that it produces significant noise that can be in excess of 140 dB.

To enable its use of such a machine in general commercial applications, the noise should be reduced to below 85 dB, an accepted international standard. To achieve a noise level that meets the legal requirements of a workplace at which the vortex machine may find application, specific noise attenuation is required. For example, in Australia the national standard for exposure to noise in the occupational environment is an eight-hour equivalent continuous A-weighted sound pressure level, LAeq,8h, of 85 dB(A).

The invention in WO 2018/187848 therefor provided a housing for the vortex machine. Which housing includes an enclosure incorporating at least one layer of noise attenuation materials surrounding the aero-acoustic processing machine, the enclosure having a material inlet port, an air inlet port and an exhaust port for outputting processed product with air. Airflow paths that are required for operation of the vortex machine are provided to enable airflow into the housing whilst significantly reducing noise emission.

The above patent applications did not solve the problems of excessive wear of parts of the apparatus (vortex machine) and did not address the complexity of comminuting both moist and dry materials, whether hard or soft.

The inventor thus proposes improvements which address these and other problems.

### SUMMARY OF THE INVENTION

The aero-acoustic materials processing plant of the invention is similar in form and general configuration to that shown in WO 2018/187848 which provided a housing for the vortex machine which includes an enclosure incorporating at least one layer of noise attenuation materials surrounding the aero-acoustic processing machine, the enclosure having a material inlet port, an air inlet port and an exhaust port for outputting processed product with air. Airflow paths that are required for operation of the vortex machine are provided to enable airflow into the housing whilst significantly reducing noise emission.

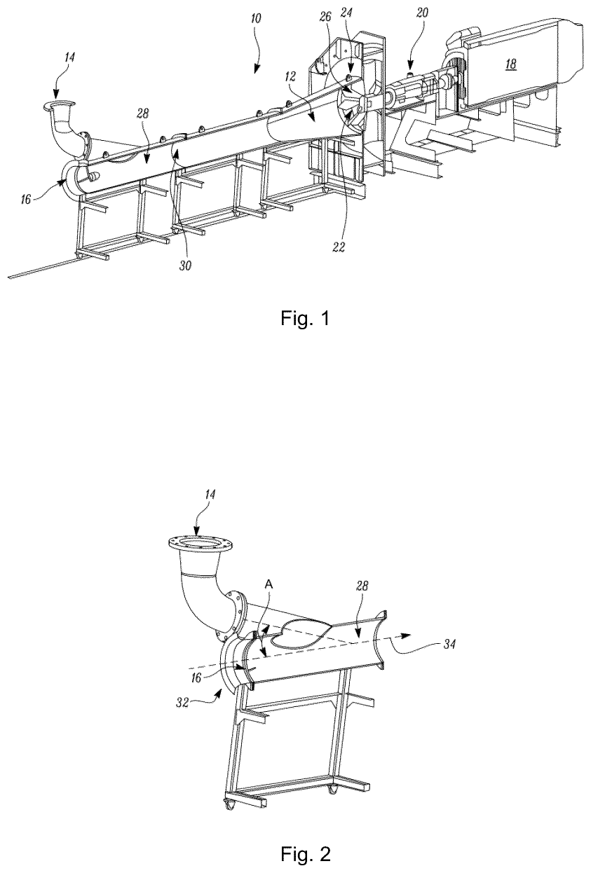

In the interests of conciseness the general aspects of that housing and enclosure will not be described here in any detail and the reader is referred to WO 2018/187848 of which FIGS. 1 to 9 and the descriptions thereof are incorporated herein by reference by way of background.

In accordance with a first aspect of the invention there is provided an aero-acoustic comminution machine having a cyclone chamber having an inlet for a material to be comminuted and an inlet for an entraining gas and a rotational drive apparatus coupled to rotate an impeller which rotates within an impeller housing to draw the entraining gas and the material to be comminuted into the cyclone chamber and through an axial inlet system into the impeller and impeller housing and to expel the comminuted material through the impeller housing radially through a transverse outlet, the plant further comprising an enclosure surrounding the aero-acoustic processing machine, the enclosure constructed to include sound attenuation panels for the reduction of noise, wherein the sound attenuation panels include 4 or more layers which together act to reduce the noise of operation of the machine when heard from outside the enclosure.

The materials processing may be comminution of the material being fed into said machine.

The sound attenuation panel may be a composite panel constructed of 4 or more layers including;
a plasticised film;
dense Rockwool;
waterproof gyprock; and
a rubberised film.

The panel may be suspended from 10 to 40 mm away from an inner surface of an inner wall of the enclosure to further reduce the transmission of noise. The panel may be suspended 20 mm away from said inner surface.

The panel may include a casing perforated on the side which in use faces the inner surface of the inner wall of the enclosure.

The panel may include a perforated steel sheet of about 4 mm thickness which in use faces the interior of the enclosure and which has a total aperture ratio of 35% with the apertures being typically 4 mm equivalent diameter.

The casing may be made of metal.

The casing may be 100 mm deep.

The panel may include a perforated sheet which in use faces the interior of the enclosure.

The perforated sheet may be made of metal, for example, galvanised steel, stainless steel, aluminium, or the like.

The perforated sheet may be 1 mm to 4 mm thick, typically 3 mm thick.

The perforated sheet may have a total aperture ratio of 35%.

The aperture size may be 2 mm to 5 mm, typically 4 mm.

The apertures may be any shape.

The enclosure has air inlets and outlets which permit air to be freely drawn into the enclosure when it is closed. Typically the air inlets have a combined total cross sectional area of from 0.5 square meter to 2 square meters.

The rotational drive apparatus includes an electrical motor.

The enclosure air inlets are located and orientated so that the air which is drawn into the enclosure flows over the electric motor cooling fins thereby to keep the electric motor within an operating temperature range.

In an embodiment of the invention, the sound attenuation panels are a composite panel constructed of 4 layers including;
a plasticised film layer of 1 mm thickness;
a dense Rockwool layer of 70 mm thickness;
a waterproof gyprock layer of 20 mm thickness; and
a rubberised film layer of 4 mm thickness.

According to a second aspect of the invention, there is provided an aero-acoustic comminution apparatus including an aero-acoustic comminution machine having a cyclone chamber having an inlet for the material to be comminuted and an inlet for the entraining gas and a rotational drive apparatus coupled to rotate an impeller which rotates within an impeller housing to draw the entraining gas and the material to be comminuted into the cyclone chamber and through an axial inlet system into the impeller and impeller housing and to expel the comminuted material through the impeller housing radially through a transverse outlet.

The entraining gas may be drawn directly into the inlet from the environment or be pre-treated or conditioned by a conditioning means prior to being drawn in to the cyclone chamber.

The length of the cyclone chamber may be variably adjustable by slidingly displacing a trumpet portion relative to a tubular portion of the cyclone chamber at the open end thereof.

The entrained gas inlet may be an end opening of the cyclone chamber and be flared with an outer diameter of 0.5 meter to 1.5 meter, typically 1 meter.

The material to be comminuted inlet into the cyclone chamber may be acutely angled in the direction of flow of the entraining gas relative the longitudinal axis of the cyclone chamber, wherein the acute angle is between 15 and 18 degrees from the horizontal, typically 16 degrees from the horizontal (measured relative to the axis of the cyclone chamber). The inner diameter of said intake at its opening where the material to be comminuted is added is between 300 mm and 400 mm, typically 356 mm. The inner diameter of said intake where the material enters the cyclone chamber may be from 325 mm, to 375 mm, typically 336 mm.

The gas intake and the material intake are made of steel having a wall thickness of from 5 mm to 15 mm, typically 10 mm. The intakes are typically pipe.

The material intake may be at between the 9 o'clock and 12 o'clock position into the cyclone chamber when viewed axially.

The cyclone chamber has an inner diameter of from 300 mm to 400 mm after the material inlet and flares to a diameter of from 500 mm to 750 mm at the impeller housing, typically it increases in diameter from 336 mm at the material inlet end to 640 mm at the impeller housing end. The flaring zone may be from 1500 mm to 2500 mm, typically 2000 mm.

The impeller housing may have an internal surface with an asymmetrical configuration so that the gap between the impeller and the housing is not constant around the circumference of the impeller.

The gap between the impeller and the internal surface of the impeller housing may vary over its extent.

The linear velocity of the entraining gas in the cyclone chamber at its impeller end may be from 200 to 260 m/s.

The impeller housing transverse outlet may be from 0.4 square meters to 1.2 square meters, typically about 0.55 square meters. The transverse outlet may be 0.74×0.74 meters.

The impeller may be a radial fan or blower impeller having a set of impeller vanes secured between two plates, an intake opening being provided on a central zone of one of the plates, the intake opening having a series of fixed vanes distributed around a central hub dimensioned and orientated for inducing a desired flow characteristic as the gas is drawn into the impeller.

The impeller vanes may be scoop like extending radially from the hub to the periphery of the plates thereby to define the impeller.

The impeller may have an intake diameter of from 0.5 to 0.8 meters, typically 0.6096 meters (24″) and an outer diameter of 0.75 to 1.1 meters, typically 0.9144 meters (36″).

The impeller may be made of steel, typically having a nitrided steel surface to resist wear.

The impeller may be driven by an electric motor at a rotation speed of from 2000 rpm to 5000 rpm, typically 3300 to 3500 rpm. The speed of rotation will depend on the material being comminuted.

According to a further aspect of the invention, there is provided a method of comminuting an ore material, for example, iron ore or gold ore, wherein the plant including the comminution apparatus described above is used, the method including the steps of:
drawing ambient air as an entraining gas into the inlet opening of the cyclone chamber to accelerate the air from 0 to 260 m/s; and
feeding particulate ore material with a hardness of 10-450 MPa and a particle size characterisation 0-25 mm with a moisture content of 0-65% m/m, said particulate ore being fed into the material inlet at a rate of 0-25 tph;
thereby to comminute the ore to particles in the particle characterisation range of 0-500 μm.

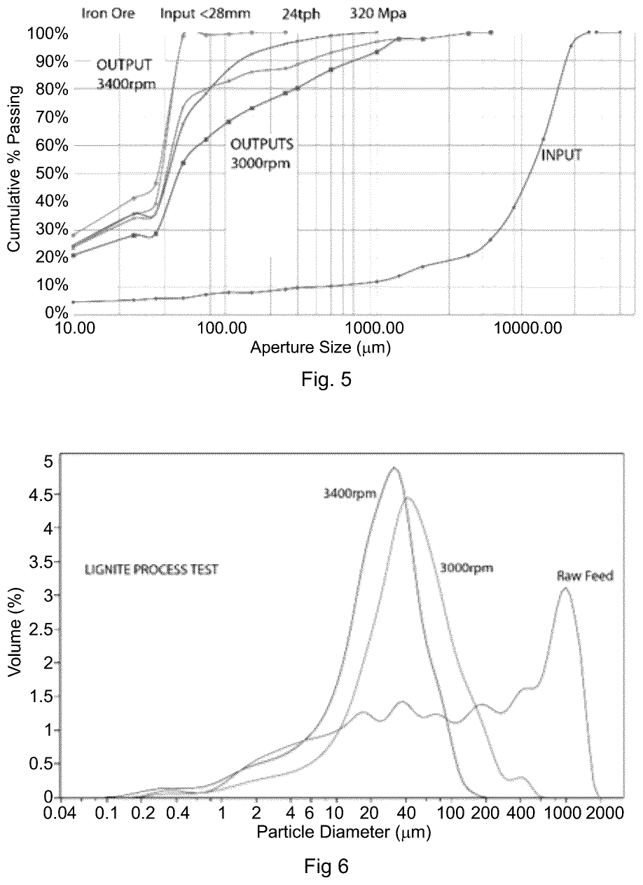

An example of the particle distribution is shown in the graphs in FIGS. 5 and 6.

According to a further aspect of the invention, there is provided a method of comminuting an organic material wherein the plant including the comminution apparatus described above is used, the method including the steps of:
drawing air as an entraining gas into the inlet opening of the cyclone chamber at ambient conditions;
particulate organic material with a particle size characterisation particle size from 0-3000 μm with a moisture content of 0-60% m/m, said particulate material being fed into the material inlet at a rate of 10-15 tph;
thereby to comminute the material to particles in the particle characterisation range of 0-500 um.

The comminuted organic material may have a moisture content below 10% m/m.

### DESCRIPTION OF EMBODIMENTS OF THE INVENTION

The invention will now be described by way of non-limiting examples with reference to the accompanying diagrammatic drawings. In the drawings,

FIG. 1 shows an aero-acoustic comminution apparatus including an aero-acoustic comminution machine;

FIG. 2 shows a cross section of a portion of the cyclone chamber having an inlet for the material to be comminuted and an inlet for the entraining gas of the machine of FIG. 1;

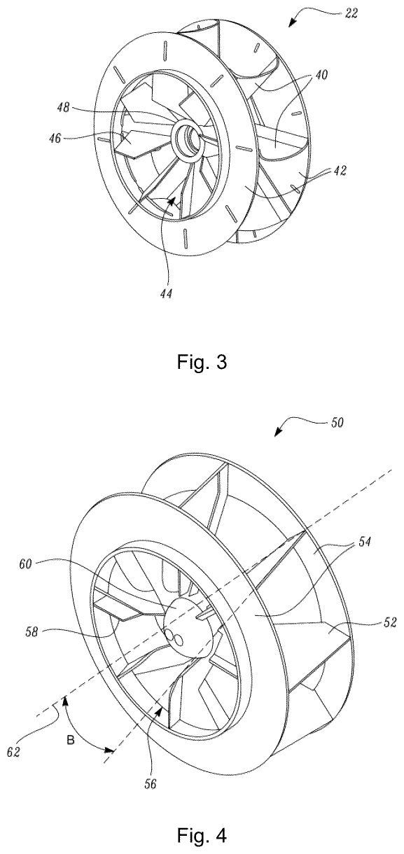

FIG. 3 shows the impeller of the machine of FIG. 1;

FIG. 4 shows another version of an impeller of the machine of FIG. 1;

FIG. 5 shows particle size data for iron ore; and

FIG. 6 shows particle size distribution for lignite.

In FIGS. 1 to 3, an aero-acoustic comminution apparatus includes an aero-acoustic comminution machine 10 having a cyclone chamber 12 with an inlet 14 for the material to be comminuted and an inlet 16 for the air. An electric motor 18 coupled to a shaft 20 to which an impeller 22 is coupled rotates the impeller 22 within an impeller housing 24 to draw the air and the entrained material to be comminuted into the cyclone chamber 12 and through an axial inlet system 26 into the impeller 22 and impeller housing 24 and to expel the comminuted material through the impeller housing 24 radially through a transverse outlet.

The length of the cyclone chamber, and thus the air inlet position, is variably adjustable by slidingly displacing a trumpet portion 28 relative to a tubular portion of the cyclone chamber 12 at the open end thereof. The air inlet 16 may have a diameter of 1 m at the trumpet portion 28 edge 32.

The flat tangential angle A of the inlet pipe 14 allows material to enter the intense vortex airflow in the cyclone 12 with minimum disruption to vortex that exists in the center of the cyclone 12. The inlet pipe 14 can be set to an angle A of 17 degrees to the centre line 34 to allow the particles to be processed to accelerate to over 200 mps while still in the inlet pipe 14 causing minimum effect on the air speed or the vortex forces of the cyclone 12.

The material to be comminuted inlet into the cyclone chamber 12 is angled at 17 degrees in the direction of flow of the entraining air relative the longitudinal axis centre line 34 of the cyclone chamber 12 and at between the 9 o'clock and 12 o'clock position into the cyclone chamber 12 when viewed axially. The inner diameter of said intake 14 at its opening where the material to be comminuted is added is typically 356 mm. The inner diameter of said intake where the material enters the cyclone chamber 12 is typically 336 mm.

The air intake 16 and the material intake 14 are made of steel having a wall thickness of typically 10 mm. The intakes are typically pipe.

The cyclone chamber 12 has an inner diameter of 336 mm at the material inlet 14 end and increases to 640 mm at the impeller housing 24 end i.e. it flares towards the impeller housing 24.

The impeller housing 24 has an internal surface (not shown) with an asymmetrical configuration so that the gap between the impeller 22 and the housing 24 is not constant around the circumference of the impeller 22. Thus, in use, the gap between the impeller 22 and the internal surface of the impeller housing 24 varies over its extent.

The linear velocity of the air flowing through the cyclone chamber 12 at its impeller 22 end may be from 230 to 260 m/s.

The impeller housing 24 transverse outlet is typically about 0.55 square meters (0.74×0.74 meters).

The impeller 22 shown in FIG. 3, is a radial fan impeller having a set of impeller vanes 40 secured between two plates 42, an intake opening 44 being provided on a central zone of one of the plates 42, the intake opening 44 having a series of fixed vanes 46 distributed around a central hub 48 dimensioned and orientated for inducing a desired flow characteristic as the gas is drawn into the impeller 22. The impeller vanes 40 in this embodiment are scoop like extending radially from the hub 48 to the periphery of the plates 42 thereby to define the impeller 22.

The impeller 22 has an intake diameter of from typically 0.6096 meters (24″) and an outer diameter of typically 0.9144 meters (36″).

The impeller 22 of this embodiment is made of steel having a nitrided steel surface to resist wear.

The impeller 22 has a rotation speed of from 3300 to 3500 rpm but the speed of rotation will depend on the material being comminuted.

The embodiment of impeller 50 shown in FIG. 4, is a radial fan impeller having a set of impeller vanes 52 secured between two plates 54, an intake opening 56 being provided on a central zone of one of the plates 54, the intake opening 56 having a series of fixed vanes 58 distributed around a central hub 60 dimensioned and orientated for inducing a desired flow characteristic as the gas is drawn into the impeller. The vanes 52 in this embodiment have a flat profile and are angled at an angle B of up to 15 degrees off the center line 62 of the shaft 20 to promote a more efficient and dispersed particle flow through the impeller 50. This also reduces the stress and pressure on the metal vanes 52, and the wear on the surface of the vanes 52.

In FIG. 5 particle size characterisation data for iron order processed by the apparatus of the invention is shown. The iron ore was fed into the apparatus at a rate of 24 tph at a particle size of below 28 mm and a hardness of about 320 MPa with different impeller rotation speeds as indicated on the figure. As can be seen, at higher impeller RPM smaller particle size characterisations were obtained.

In FIG. 6, a particle size characterisation was carried out for lignite again at different impeller speeds. Again, the effect of the higher impeller speed can be seen.

What can be seen from both FIGS. 5 and 6 is that the apparatus of the invention is effective in comminuting both very hard materials, such as ore, and more fragile softer materials such as lignite.

1.-32. (canceled)

33. An aero-acoustic materials processing plant, comprising an aero-acoustic comminution machine having a cyclone chamber having an inlet for a material to be comminuted and an inlet for an entraining gas and a rotational drive apparatus coupled to rotate an impeller which rotates within an impeller housing to draw the entraining gas and the material to be comminuted into the cyclone chamber and through an axial inlet system into the impeller and impeller housing and to expel the comminuted material through the impeller housing radially through a transverse outlet.

34. The processing plant as claimed in claim 33, comprising an enclosure surrounding the aero-acoustic processing machine, the enclosure constructed to include sound attenuation panels for the reduction of noise, wherein the sound attenuation panels include 4 or more layers which together act to reduce the noise of operation of the machine when heard from outside the enclosure; wherein the sound attenuation panels are in the form of a composite panel constructed of 4 or more layers including;
a plasticised film;
dense Rockwool;
waterproof gyprock; and
a rubberised film.

35. The processing plant as claimed in claim 33, wherein the entrained gas inlet is an end opening of the cyclone chamber and is flared with an outer diameter of 0.5 meter to 1.5 meter.

36. The processing plant as claimed in claim 33, wherein the cyclone chamber length is variably adjustable by slidingly displacing a trumpet portion relative to a tubular portion of the cyclone chamber at the open end thereof.

37. The processing plant as claimed in claim 33, wherein the inlet for the material to be comminuted has an inner diameter at its opening where the material to be comminuted is added of between 300 mm and 400 mm and the inner diameter of said intake where the material enters the cyclone chamber is from 325 mm to 375 mm.

38. The processing plant as claimed in claim 33, wherein the gas intake and the intake for the material to be comminuted are made of steel having a wall thickness of from 5 mm to 15 mm.

39. The processing plant as claimed in claim 33, wherein the cyclone chamber has an inner diameter of from 300 mm to 400 mm after the inlet for the material to be comminuted and flares in a flaring zone to a diameter of from 500 mm to 750 mm at the impeller housing.

40. The processing plant as claimed in claim 39, wherein the cyclone chamber increases in diameter from 336 mm at the intake for the material to be comminuted end to 640 mm at the impeller housing end and the flaring zone is from 1500 mm to 2500 mm in length.

41. The processing plant as claimed in claim 33, wherein the impeller housing transverse outlet is from 0.4 square meters to 1.2 square meters.

42. The processing plant as claimed in claim 33, wherein the impeller is a radial fan or blower impeller having a set of impeller vanes secured between two plates, an intake opening being provided on a central zone of one of the plates, the intake opening having a series of fixed vanes distributed around a central hub dimensioned and orientated for inducing a desired flow characteristic as the gas is drawn into the impeller, wherein he impeller vanes are scoop like extending radially from the hub to the periphery of the plates thereby to define the impeller.

43. The processing plant as claimed in claim 33, wherein the impeller is a radial fan or blower impeller having a set of impeller vanes secured between two plates, an intake opening being provided on a central zone of one of the plates, the intake opening having a series of fixed vanes distributed around a central hub dimensioned and orientated for inducing a desired flow characteristic as the gas is drawn into the impeller, wherein he impeller vanes have a flat profile and extend radially from the hub to the periphery of the plates thereby to define the impeller, said vanes being angled at an angle of up to 15 degrees off a center line of the cyclone chamber to promote a more efficient and dispersed particle flow through the impeller.

44. The processing plant as claimed in claim 43, wherein the impeller has an intake diameter of from 0.5 to 0.8 meters, and an outer diameter of 0.75 to 1.1 meters.

45. The processing plant as claimed in claim 44, wherein the impeller is made of steel having a nitrided steel surface to resist wear.

46. A method of comminuting an ore material using an aero-acoustic comminution apparatus including an aero-acoustic comminution machine having a cyclone chamber having an inlet for a material to be comminuted and an inlet for an entraining gas and a rotational drive apparatus coupled to rotate an impeller which rotates within an impeller housing to draw the entraining gas and the material to be comminuted into the cyclone chamber and through an axial inlet system into the impeller and impeller housing and to expel the comminuted material through the impeller housing radially through a transverse outlet, the method including the steps of:
drawing ambient air as an entraining gas into the inlet opening of the cyclone chamber to accelerate the air from 0 to 260 m/s; and
feeding particulate ore material with a hardness of 10-450 MPa and a particle size characterisation 0-25 mm with a moisture content of 0-65% m/m, said particulate ore being fed into the material inlet at a rate of 0-25 tph;
thereby to comminute the ore to particles in the particle characterisation range of 0-500 μm.

47. A method of comminuting an organic material including using an aero-acoustic comminution machine having a cyclone chamber having an inlet for a material to be comminuted and an inlet for an entraining gas and a rotational drive apparatus coupled to rotate an impeller which rotates within an impeller housing to draw the entraining gas and the material to be comminuted into the cyclone chamber and through an axial inlet system into the impeller and impeller housing and to expel the comminuted material through the impeller housing radially through a transverse outlet, the method including the steps of:
drawing air as an entraining gas into the inlet opening of the cyclone chamber at ambient conditions;
particulate organic material with a particle size characterisation particle size from 0-3000 μm with a moisture content of 0-60% m/m, said particulate material being fed into the material inlet at a rate of 10-15 tph;
thereby to comminute the material to particles in the particle characterisation range of 0-500 μm.

48. A method of comminuting an organic material including using an aero-acoustic comminution machine as claimed in claim 47, wherein the comminuted organic material has a moisture content below 10% m/m.

49. The processing plant as claimed in claim 34, wherein the panel is suspended from 10 to 40 mm away from an inner surface of an inner wall of the enclosure to further reduce the transmission of noise.

50. The processing plant as claimed in claim 49, wherein the panel includes a casing perforated on a side which in use faces the inner surface of the inner wall of the enclosure.

51. The processing plant as claimed in claim 50, wherein the panel includes a perforated steel sheet of about 4 mm thickness which in use faces the interior of the enclosure and which has a total aperture ratio of 35% with the apertures being typically 4 mm equivalent diameter.

52. The processing plant as claimed in claim 51, wherein the casing is made of metal and is 100 mm deep.
